(19) United States
(12) Patent Application Publication
(10) Pub. No.: US 2006/0271913 A1
(43) Pub. Date: Nov. 30, 2006

(54) Method and system for providing a field configurable guide

(76) Inventor: Franklin K. Erf, Cupertino, CA (US)

Correspondence Address: STRATEGIC PATENT GROUP, P.C., P.O. BOX 1329, MOUNTAIN VIEW, CA, 94042, US

(21) Appl. No.: 11/141,835

(22) Filed: May 31, 2005

(51) Int. Cl. G06F 9/44

(52) U.S. Cl. 717/120

(57) ABSTRACT

A method and system for providing a field customizable guide are described. The method and system include receiving a selection of at least one object type by an end-user and allowing addition by the end-user of contents relating to each of the at least one object type. Each of the at least one object includes a plurality of attributes. The contents also include at least one field. The method and system may also include allowing entry by the end-user of validation information for each of the at least one object type and allowing selection by the end-user of a plurality prompts. The method and system further include automatically generating the guide based on the at least one object type, the contents, and where applicable, the validation information, and the plurality of prompts provided by the end-user.

### FIELD OF THE INVENTION

The present invention relates to guides, especially for compensation manager applications, and more particularly to providing a guide that can be field configured by an end-user and that is preferably for a compensation manager application.

### BACKGROUND OF THE INVENTION

Conventional compensation manager applications are used to manage information relating to the compensation of employees of an organization. Conventional compensation manager applications are particularly useful in determining compensation for employees whose compensation is based at least in part on transactions. For example, a compensation manager application might be used to determine compensation for a sales force that is paid at least partly by commission. Thus, the conventional compensation manager would take transactions, access data referenced such as the individual(s) who may receive compensation and the compensation plans that determine how to calculate compensation, then perform the calculation. This calculation of compensation for such employees may be difficult, particularly for an organization having a large number of employees and/or engaging in a large number of transactions that affect compensation. However, conventional compensation manager applications can also be used for employees that receive the bulk of their compensation through a salary. In addition, conventional compensation manager application may also be used to manage other information, for example relating to employees' time with the organization, benefits, and position within the company.

FIG. 1 is a block diagram of a conventional form 10 used by a conventional compensation manager application. The conventional form 10 includes fields 12, 14, 16, 18, and 20. The conventional form 10 can relate to various aspects of the organization such as the compensation plan used, information regarding employees, products sold, the transactions taking place, and other policies or characteristics of the organization. The conventional form 10 is used by an administrator or other authorized user to enter information into the conventional compensation manager application. Once the information is entered, the conventional compensation manager application can calculate compensation for each employee as well as perform other operations.

The fields 12, 14, 16, 18, and 20 allow the user to provide information to the compensation manager application in a manner that the compensation manager applicant can use and recognize. For example, in the conventional form 10, the user is allowed to enter the employee's name and/or identification in the field 12 and the employee's base pay (if any) in field 14. The field 16 allows the particular compensation plan, which may indicate which transactions result in compensation and how much the compensation is, to be input. The security level of the employee can be entered in field 18. The user may enter other information in the field(s) 20.

In order to facilitate entry of information into conventional forms 10, conventional compensation management guides, or wizards, are provided. Conventional compensation manager guides indicate to the user which fields 12, 14, 16, 18, and 20 in a particular form 10 must be filled out. For example, a conventional compensation manager guide may include pages that prompt a user to enter data into a field 12, 14, 16, 18, or 20, as well as the type of data to be entered. The conventional compensation manager guide may also validate the data entered into one or more of the fields 12, 14, 16, 18, and 20. The conventional compensation manager guide may also cause the conventional compensation manager application to provide other forms (not shown) based upon the user's responses to the conventional compensation manager guide's prompts and data entered into the fields 12, 14, 16, 18, and 20. Thus, the user can complete the process of entering the information required for desired tasks under the instruction of the conventional compensation manager guide.

Although conventional compensation manager guides can assist a user in correctly filling out the conventional form 10, one of ordinary skill in the art will readily recognize that organizations may vary greatly. Each organization may have different policies, different compensation plans, different products, different required employee information, different types of identification numbers for employees, as well as other differences. These varying attributes of organizations are reflected in the conventional compensation managers themselves. Consequently, conventional compensation manager applications are customized for individual organizations, typically by the vendor of the conventional compensation manager application. In order to be able to guide users through tasks for these varying conventional compensation managers, the conventional compensation manager guides must also be individually tailored for each organization. This customization is also typically accomplished by the vendor of conventional compensation manager applications. Thus vendors of conventional compensation managers expend time, manpower, and other resources to customize conventional compensation managers, as well as conventional compensation manager guides, to individual clients.

Accordingly, what is needed is an improved method and system for providing a field customizable guide. The present invention addresses such a need.

### BRIEF SUMMARY OF THE INVENTION

The present invention provides a method and system for providing a field customizable guide. The method and system comprise allowing selection of at least one object type by an end-user and allowing addition by the end-user of contents relating to each of the at least one object type. Each of the at least one object includes a plurality of attributes. The contents also include at least one field. The method and system may also comprise allowing entry by the end-user of validation information for each of the at least one object type and allowing selection by the end-user of a plurality prompts. The method and system further include automatically generating the guide based on the at least one object type, the contents, and where applicable, the validation information, the plurality of prompts provided by the end-user, and multilingual support.

According to the method and system disclosed herein, the present invention provides a guide, particularly for use with a compensation manager application, that is field customizable by the end-user.

### BRIEF DESCRIPTION OF SEVERAL VIEWS OF THE DRAWINGS

FIG. 1 is a block diagram of a conventional form.

FIG. 2 is a flow chart depicting one embodiment of a method in accordance with the present invention for providing a field customizable guide.

FIG. 3 is a flow chart depicting another embodiment of a method in accordance with the present invention for providing a field customizable guide for a compensation manager application.

FIG. 4 is a flow chart depicting another embodiment of a method in accordance with the present invention for providing a field customizable guide for a compensation manager application.

FIG. 5 depicts one embodiment of a field customizable guide generated using the method and system in accordance with the present invention.

FIG. 6 is a block diagram of one embodiment of a system in accordance with the present invention for providing a field customizable guide.

FIG. 7 is a block diagram of one embodiment of a system in accordance with the present invention for providing a field customizable guide for a compensation manager application.

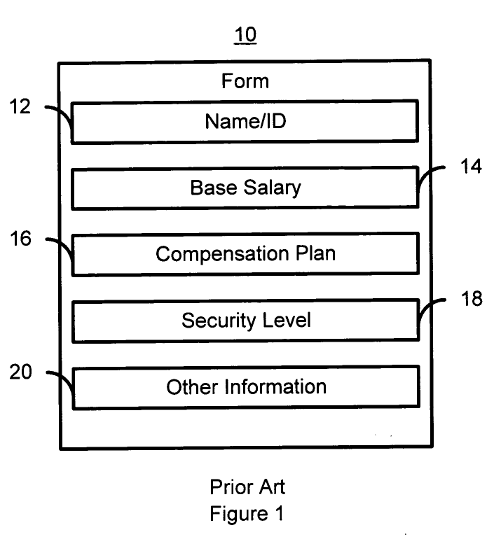

### DETAILED DESCRIPTION OF THE INVENTION

The present invention relates to a method and system for providing a field customizable guide. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

The present invention will be described in terms of a particular method and field customizable guide. However, one of ordinary skill in the art will readily recognize that the method and system are consistent with other methods and guides having different and/or additional steps and components. In addition, the present invention is described in the context of a field customizable compensation manager guide used for compensation manager applications. One of ordinary skill in the art will readily recognize, however, that the method and system may be used to provide guides for other applications.

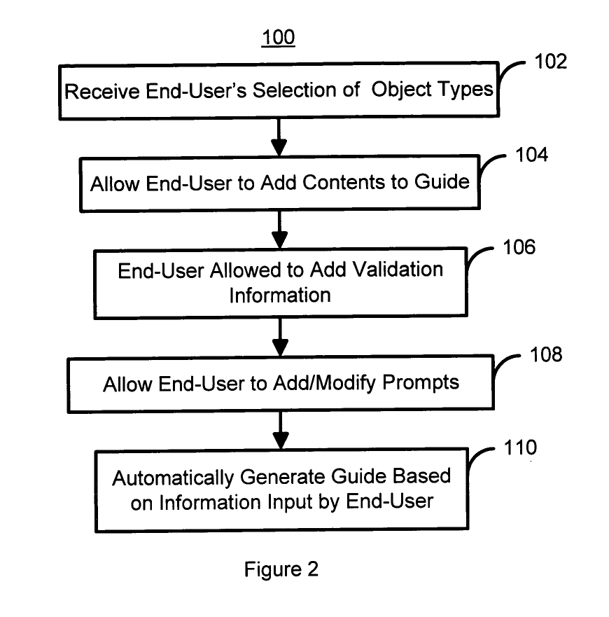

To more particularly describe the method and system in accordance with the present invention, refer to FIG. 2, depicting one embodiment of a method 100 in accordance with the present invention for providing a field customizable guide. The method 100 is used with an underlying application. In a preferred embodiment, the underlying application is a compensation manager application. In a preferred embodiment, the compensation manager application finds primary utility in managing transaction based compensation, for example commissions. The compensation manager application also preferably manages other tasks and includes other information, for example calculating salary-based compensation, managing the compensation plans for employees in the organization, managing benefits for the employees, and managing other employee information. The guide provided using the method 100 can lead users through a process required to perform various tasks. In particular, the guide provides pages, pop ups, or uses other mechanisms that lead a user through the data required to be entered for the underlying application to perform particular operations. Thus, the guide is preferably associated with forms for the underlying application and may assist the user in filling out fields in the forms. Also in a preferred embodiment, the forms for the compensation manager application corresponding to the guide are also generated through the method 100. In some embodiments, the guide may also validate the data provided by the user and/or may cause other forms to be provided to the user for information to be input. In addition, note that the method 100 may be used to create a new guide, or may be used to modify a preexisting guide.

The end-user of the application is allowed to select one or more data objects, via step 102. Such data objects have various attributes. Moreover, the data objects are generally associated with certain tasks performed by the underlying application. For example, an employee of the organization may have a name, position title, social security number, a corresponding compensation plan, and a security level. The guide is to be used to lead users through a process required to perform particular tasks for the data objects. For example, the data object might correspond to an employee of the organization, an aspect of the underlying application such as the generation of reports, various plans used by the organization and managed by the underlying application, various positions which employees may hold, or other data. Tasks associated with a particular data object, such as an employee, could include calculation of compensation and modifying the attributes of the data object. Selection of a data object in step 102 may include selecting a data object from a set of pre-existing data objects. If a new data object is created, then step 102 may also include defining the attributes of the data object. Step 102 may include performing a search for particular data object(s). In a preferred embodiment, the data object selected belongs to one of the types: Organizational Data, Classification Data, Plan Data, Result Data, and Administrative data. Organizational Data includes: participants, positions, titles, relationships, and position groups. Classification Data includes: categories, products, customers, postal codes, and custom classifiers. Plan Data includes object types: plans, rules, formulas, variables, territories, rate tables, fixed values, quotas, and lookup tables. Result Data includes object types: pipeline runs, models, orders, transactions, credits, measurements, incentives, commissions, deposits, payments, earning codes, earning groups, event types, and reason codes. Administrative Data includes object types: users, roles, logs, unit types, calendars, business units, and processing units. The end-user allowed to perform the selection in step 102 is typically an individual employed by the organization to use the underlying application. For example, for a compensation manager application, the end-user is typically an administrator charged with overseeing compensation of employees. Furthermore, step 102 may include creating and/or selecting multiple objects for a particular guide.

Once the user has selected the data object(s), the user is allowed to add content to the guide, via step 104. In one embodiment, adding content includes adding a page and defining the field(s) for the form corresponding to the page. The fields allow the user to provide information to the compensation manager application in a manner that the compensation manager applicant can use and recognize. Also in step 104, the user indicates to which object and/or attribute of the object the field corresponds. For example, if the data object is an employee, the fields may include the employees name and identification, the corresponding compensation plan, job title, security clearance, benefits, or other information. In one embodiment, adding content could include forming page groups from pages which may already exist. The page groups may correspond to a particular task and may be used by other guides. Furthermore, if one or more of the data object(s) selected in step 102 were in a preexisting guide, then the addition of contents in step 104 may include modifying or supplementing the preexisting guide. Such modifications can include deleting portions of the preexisting guide. Step 104 may also include specifying different locales that may be supported. Different locales may have different languages. Thus, multilingual support may be provided through step 104. In addition, the format for dates, format for numbers, and currencies may be different for different locales. Support for different locales may also account for these differences based on content provided in step 104.

In some embodiments, the end-user is optionally allowed to add validation information, via step 106. The validation information corresponds to particular fields selected in step 104 and allows the guide to check data that will be provided in the fields to ascertain whether the data falls within desired parameters. For example, data may be required to fall within a particular numeric range or may be required to be selected from a list of allowed responses such as a particular security level. Step 106 may also include allowing the input data to be validated by checking the input data against data stored in a repository. Thus, step 106 may include selecting a method of validating the input data, such as a numeric calculation or matching one or more items on a list. Step 106 may also include providing a set of values used in the validation method. These values may be specific data which the input data must match or may be used in the calculation performed to determine whether the input data is valid. Thus, step 106 allows the end-user to select how data for a particular data object and the form corresponding to the guide are validated.

The end-user is allowed to select various prompts relating to the at least one object type, the contents, and/or the validation information, via step 108. Step 108 may include modifying default prompts. For example, step 108 may include defining or modifying prompts which cause the user to check spelling, grammar, punctuation, required fields which do not yet have data input, or other messages desired to be provided by the guide. The user may also specify different text in the prompt(s) for each locale to be supported. The guide is automatically generated based on the at least one object type, the contents, and if applicable, the validation information and prompts, via step 110. Step 110 preferably simply includes saving the data for the guide and making the guide available to the underlying application. Step 110 may also include generating the form corresponding to the guide, generating the page(s) of the guide, and linking the guide to the corresponding form. However, generating the guide, generating the form, and linking the guide to the form preferably occur at run time. In a preferred embodiment, the layout of the page(s) of the guide follows a set of default rules, which may also be changed by the end-user. For a preexisting guide that is being updated, generation of the guide in step 110 may simply include generating new and/or updated pages of the guide, while leaving the remaining portions of the guide intact. Step 110 also includes managing the layout of the guide such that the guide can be presented appropriately on different user interfaces. For example, the guide may be presented on interfaces for a web-based or a stand alone application. The data objects, content, validation information, prompts and other information provided by the user in steps 102-108 are then incorporated into the layout prescribed by a guide engine, described below. Moreover, because the user associated fields with objects and/or attributes of the objects in step 104, the guide generated in step 110 may update the associated object and may pull input data to other appropriate associated fields.

Thus, using the method 100, a new guide may be generated by the end-user or a preexisting guide may be modified. In some embodiments, the preexisting guide may have been provided by the vendor of the underlying application or may have been previously generated by the end-user. Consequently, a field customizable guide may be provided. As a result, the particular characteristics of the organization for which the underlying application is used may be taken into account without requiring the vendor to expend resources required to customize the guide to individual organizations. Moreover, the end-user can update the guide to account for changes in the organization, such as a change in policies or availability of particular options. For example, the compensation plans offered by the organization may change. The end-user can modify the contents of the guide, including changing the validation parameters for compensation plans, to account for this change. Consequently, the guide can not only be customized for a particular organization, but can be dynamically updated as the organization changes.

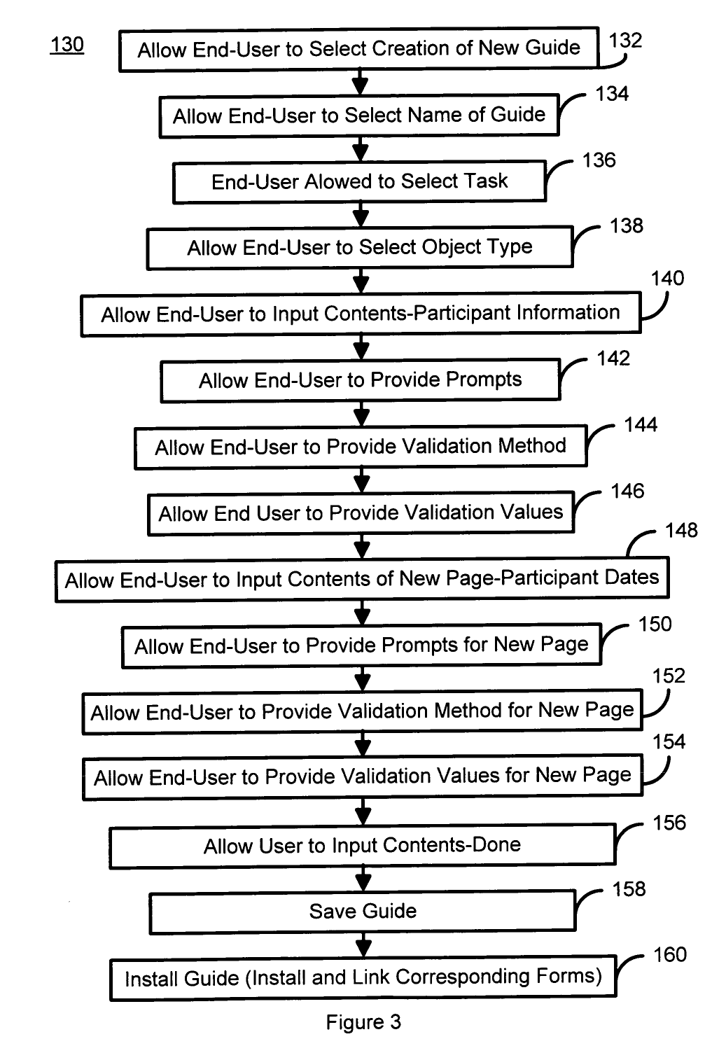

FIG. 3 is a flow chart depicting another embodiment of a method 130 in accordance with the present invention for providing a field customizable guide for a compensation manager application. The method 130 is exemplary in nature to illustrate a particular guide that might be provided. Using the method 130, an end-user is allowed to create a new guide for adding a participant, or employee, for whom the underlying compensation manager application will calculate compensation.

The process begins by allowing the end-user to select creation of a new guide, via step 132. In one embodiment, step 132 may be performed by allowing the user to select this option from a menu. The end-user is allowed to provide the name of the guide, via step 134. For this guide, the user might be allowed to input “New Participant” as the name, then select “Next” once the name is input. The user is allowed to select the desired task, via step 136. In this case, the user would opt to choose the data object. The user is allowed to select the object type, via step 138. Because a participant is a typical data object for a compensation manager program, step 138 may be performed by allowing the user to select “participant” from a list of data object types. The end-user is allowed to input contents for a page of the guide being formed, via step 140. In this case, the end-user may select various attributes for the page such as fields for the participant's name, tax identification number (social security number), employee identification, base salary, and security level. The end-user is allowed to provide the prompts, informational messages, and warnings for the page, via step 144. For example step 144 may include providing a warning that the object “Position” must be assigned to a plan in order to be processed. A prompt might indicate that the user should check the capitalization of the participant's name, via steps 144 and 142. The end-user is allowed to provide validation information, via steps 144 and 146. The end-user selects the validation method and values, respectively, in steps 144 and 146. For example, the user may opt to select validation values from a list in step 144 and provide the list of valid security levels in step 146.

The end-user may add additional pages to the guide. The user selects the contents for another page of the guide, via step 148. For the “participant” data object, the additional page could relate to the participant dates and the contents could include the hire date, target promotion date, days to maximum output, and effective dates. Consequently, an end-user may add a page relating to participant dates by selecting the appropriate data object in step 148. Furthermore, step 148 could include querying a repository of data objects which are associated with the participant (the original data object selected in step 138). This facilitates selection of a data object for the additional pages, allowing the end-user to more easily add related pages. The end-user adds the corresponding prompts and validation information in steps 150 and steps 152-154. For example, the user may add or change default prompts regarding capitalization in step 150. The user may select the validation method and values in steps 152-154. For example, the user may again set the security in steps 152-154 by selecting validation values from a list in step 152 and providing the list of valid security levels in step 154.

The user is again allowed to add content to the guide, via step 156. If the user has completed the guide, the user may select “Done.” The user can then opt to save the guide, via step 158 and install the guide, via step 160. In a preferred embodiment, the guide is saved as a flat XML file in step 158. During installation, the XML file is made available to the underlying application such as a compensation manager application. Step 160 thus includes laying out and generating the pages of the guide, preferably in accordance with rules provided by the vendor. In a preferred embodiment, the guide as well as the corresponding forms are generated and linked at run time.

Thus, using the method 130, a user is allowed to create a new guide to aid the user in performing particular tasks for the compensation manager program. Because it is designed by the end-user, the new guide is customized to the particular organization for which the user works.

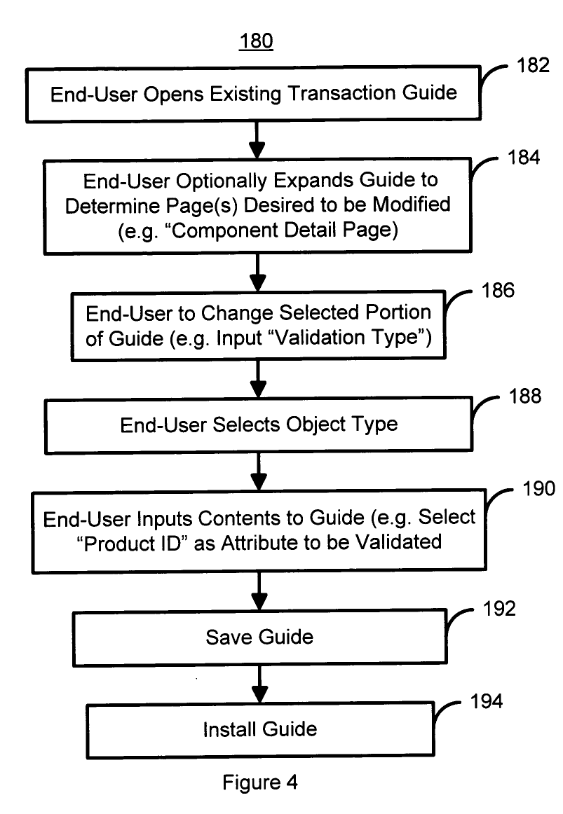

FIG. 4 is a flow chart depicting another embodiment of another method 180 in accordance with the present invention for providing a field customizable guide for a compensation manager application. The method 180 is exemplary in nature to illustrate a particular guide that might be modified. Using the method 180, the user can modify an existing guide relating to transactions. In particular, the user is modifying a preexisting guide to enforce entry of a valid product identification. However, the discussion of the method 180 can be generalized to modification of other guides.

The end-user is allowed to open an existing transaction guide, via step 182. The end-user may optionally expand the guide components, for example as a decision tree, in order to determine the page(s) that the end-user desires to modify, via step 184. Also in step 184 the user is allowed select the particular page(s) (or portions of page(s)) that are of interest. In order to enforce the valid product identification, the user may select a “component detail” page. The component detail page may list the attributes of the products sold for the transactions of interest. The end-user is allowed to change portions of the page, via step 186. In this case, the end-user desires to change the validation of the component. Consequently, the user may input the validation type as an object lookup in step 186. The end-user is allowed to select a data object type, via step 188. In this case, the user may select “product” as the data object type because validation of an attribute of a product is desired. The end-user is allowed to input contents by selecting the attribute to be validated, via step 190. The end-user may thus select the “Product ID” as the desired attribute to be validated. The user can save the guide, via step 192. The user may then opt to install the guide, via step 194. In a preferred embodiment, the guide is saved as a flat XML file in step 192. Via step 194, the guide is made available to the underlying application. At run time, the guide and the corresponding forms can then be generated and linked. This process of laying out and generating all of the pages or the modified pages of the guide, preferably in accordance with rules provided by the vendor, is handled by a guide engine described below.

Thus, using the method 180, a user can modify a preexisting guide to aid the user in performing particular tasks for the compensation manager program. Because it is designed by the end-user, the new guide is customized to the particular organization for which the user works.

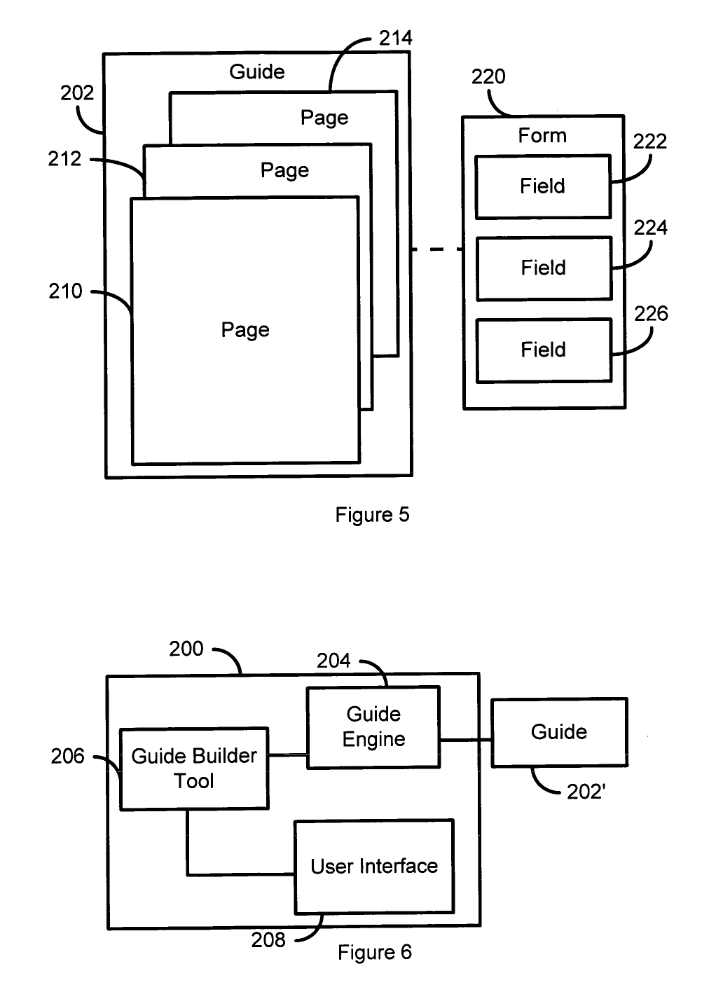

FIG. 5 depicts one embodiment of a field customizable guide 202 generated using the method and system in accordance with the present invention. The guide 202 shown includes three pages 210, 212, and 214 that are linked to a form 220 having fields 222, 224, and 226. However, another guide (not shown) may have another number of pages and be associated with another number of forms.

FIG. 6 is a block diagram of one embodiment of a software system 200 in accordance with the present invention for providing a field customizable guide 202′. The system 200 includes a guide engine 204, a guide builder tool 206, and a user interface 208. The guide 202′ corresponds to the guide 202 depicted in FIG. 5. Referring back to FIG. 6, for clarity, the system 200 will be described in the context of the guide 202′. The user interface 208 is for the guide builder tool 206. The user interface 208 provides output to and receives input from the end-user when the guide 202′ is being built or modified. Consequently, the user interface 208 preferably comprises software that receives input and displays output to/from components such as a keyboard, mouse, and display screen during creation of the guide 202′. The guide builder tool 206 leads the user through many of the steps of the methods 100, 130, and 180. Stated differently, the guide builder tool 206 is a guide, or wizard, for creation or modification of the guide 202′. The combination of the guide builder tool 206 and guide engine 204 implement the methods 100, 130 and 180.

The guide builder tool 206 may be accessed when the end-user wishes to create or modify a guide 202′ using the method 100, 130, and/or 180. The guide builder tool 206 thus accepts the input provided by the end-user through the user interface 208 and generates the menus or other prompts to the end-user for selecting objects, prompts, validation methods and validation values. The guide builder tool 206 provides output (not shown), preferably an XML guide descriptor, based on the end-user's input. The guide builder tool 206 may also provide locale specific property files (not shown) to support different locales.

The guide engine 204 accesses data related to the guide 202′ for the underlying application, accesses the output from the guide builder tool 206, and accepts the input from the end-user using a user interface (not shown in FIG. 6) for the guide engine. The guide engine 204 preferably performs these tasks at run time. For example, the guide engine 204 accesses preexisting data objects, prompts, defaults, and validation information (not shown in FIG. 6) that may reside in a repository (not shown in FIG. 6). The guide engine may also access an XML guide descriptor and locale specific property files output by the guide builder tool 206. In addition, the guide engine 204 also generates the guide 202′ based on the input received by the guide builder tool 206 and data for the underlying application. When generating the guide, the guide engine 204 manages the layout and flow of the pages 210, 212, and 214 in the guide. For example, guide engine may select where information in the pages 210, 212, and 214 are provided. The guide engine may also determine the relationship between the pages, for example when each page will be presented to the end-user, based on information provided by the guide builder tool 206. The content of the pages 210, 212, 214 and how the content is stored are thus controlled by the guide engine 204. Thus, the guide engine 204 generates and manages presentation of the guide 202′.

In operation, the end-user accesses the guide builder tool 206 through the user interface 208. The guide builder tool 206 accepts the information related to the guide from the end-user. Based on information provided by the end-user, the guide builder tool 206 outputs the data necessary for building the guide 202′. In a preferred embodiment, this output includes XML descriptors (not shown) and locale specific files (not shown) used in generating the guide 202′. Thus, using the guide builder tool 206, the end-user is able to provide and store the information for generating a customized guide 202′. Stated differently, a field-configurable guide 202′ may be set up for later use using the guide builder tool 206.

At run time, the guide engine 204 generates the guide 202′ based upon the output of the guide builder tool 206 and, therefore, the data provided by the end-user. In addition, the engine 204 accesses the appropriate information, including a preexisting guide (if applicable), data objects (not shown), validation methods allowed, and other attributes of the underlying application to which the guide may relate. In a preferred embodiment, the guide engine 204 generates the guide 202′ from XML. Thus, the guide engine 204 would parse the XML descriptors and create corresponding objects. These corresponding objects include the guide, tasks within the guide, pages for each task, the steps to be performed within each page, the user interface components that the guide will use to display and receive data, and validation logic used by various components and pages. The guide engine 204 thus cycles through tasks and pages within the guide 202′ being generated according to specified logic. During the pass through the tasks and pages, the guide engine 204 generates the pages based upon specified logic and the medium being used (e.g. a web application or a stand alone application). In particular, the guide engine 204 parses the guide descriptor and creates a guide 202′ containing a set of Tasks, Pages, Steps, Prompts, Data Entry Components, Validation Logic, and Flow Control Logic (not specifically shown in FIG. 6). This guide 202′ is combined with the locale specific property files generated by the guide builder tool 206 to display the guide 202′ to the guide user in their language. The guide engine 204 uses this information to display the Tasks and Pages in the desired order and to perform validation as needed. In addition, the flow control logic is used to skip or repeat groups of pages as needed.

Thus, using the system 200, the guide 202′ that is field configurable can be generated and/or updated. Because the guide 202′ is designed by the end-user, the new guide is customized to the particular organization for which the user works.

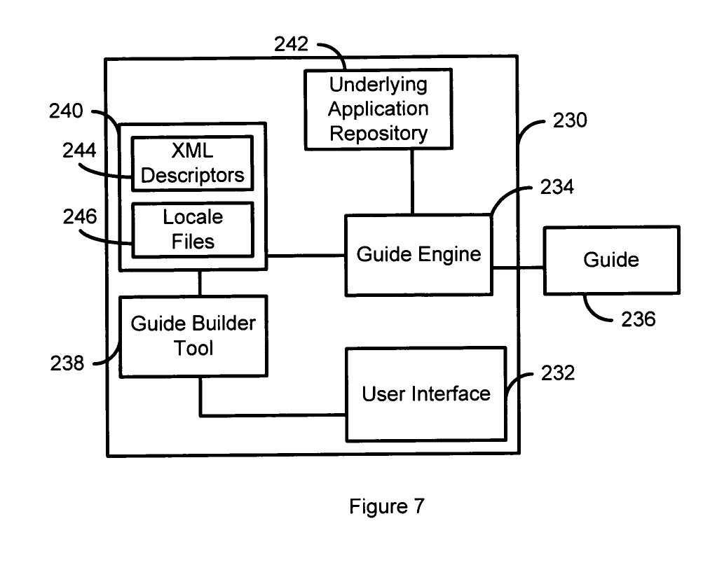

FIG. 7 is a block diagram of one embodiment of a system 230 in accordance with the present invention for providing a field customizable guide for a compensation manager application. The system 230 thus generates the guide 236 and includes a user interface 232, a guide engine 234 and a guide builder tool 238. The system also includes a configuration data 240 and the compensation manager application repository 242. The user interface 232, the guide engine 234, the guide 236 and the guide builder tool 238 preferably function substantially as described above. In addition, the guide engine 236 may obtain the data objects from and save new and modified data objects to the compensation manager application repository 242. The system 230 is preferably an XML based system. The configuration data 240 is, therefore, an XML configuration data and can be considered to include XML descriptors 244 for the guide 236 that are generated by the guide builder tool 238 as well as locale specific property files 246 used to support different locales. The configuration data 240 thus includes the output from the guide builder tool 238. In addition, the guide builder 238 stores the guide as a flat XML file.

To create or modify the guide 236, the end-user accesses the guide builder tool 238 through the user interface 232. The guide builder tool 238 accepts the information related to the guide 236 from the end-user, as described above. The guide builder tool 238 provides the XML descriptors 244 and locale specific property files 246 used by the guide engine 234 to generate the guide. At run time, the guide engine 234 generates the guide 236 based upon the output of the guide builder tool 238 and, therefore, based upon information provided by the end-user. To do so, the guide engine 234 accesses the appropriate information, including data objects from the repository 242 and the output 244 and 246 of the guide builder tool 238.

Thus, using the system 230, the guide 236 that is field configurable can be generated and/or updated. Because the guide 236 is designed by the end-user, the new guide is customized to the particular organization for which the user works.

A method and system for providing a field configurable guide has been disclosed. The present invention has been described in accordance with the embodiments shown, and one of ordinary skill in the art will readily recognize that there could be variations to the embodiments, and any variations would be within the spirit and scope of the present invention. Software written according to the present invention is to be stored in some form of computer-readable medium, such as memory, CD-ROM or transmitted over a network, and executed by a processor. Consequently, a computer-readable medium is intended to include a computer readable signal which, for example, may be transmitted over a network. Accordingly, many modifications may be made by one of ordinary skill in the art without departing from the spirit and scope of the appended claims.

We claim:

1. A computer-implemented method for providing a guide for a manager application comprising:
receiving at least one selection of at least one object type by an end-user, each of the at least one object type including a plurality of attributes;
allowing addition by the end-user of contents relating to each of the at least one object type; and
automatically generating the guide based on the at least one object type and the contents;
thereby providing the guide that is field customizable.

2. The method of claim 1 further comprising:
allowing entry by the end-user of validation information for each of the at least one object type; and
wherein the automatically generating further includes automatically generating the guide based on the at least one object type, the contents, and the validation information.

3. The method of claim 1 further comprising:
allowing selection by the end-user of a plurality prompts relating to the at least one object type, the contents, and/or the validation information; and
wherein the automatically generating further includes automatically generating the guide based on the at least one object type, the contents, and the plurality of prompts provided by the end-user.

4. The method of claim 1 wherein the addition of contents allowing further includes:
allowing the end-user to define a name for at least one page corresponding to a portion of the plurality of objects for each of the at least one object;
allowing a user to specify at least one field for data entry.

5. The method of claim 1 wherein the guide includes a plurality of pages and where the addition of contents allowing further includes grouping a plurality of pages.

6. The method of claim 1 wherein the validation information entering step further includes:
selecting at least one method for validating data provided by the user.

7. The method of claim 6 wherein the validation information entering step further includes:
selecting a plurality of values for the validation information.

8. The method of claim 1 wherein the object type includes at least one of participants, positions, titles, relationships, position groups, categories, products, customers, postal codes, custom classifiers, plans, rules, formulas, variables, territories, rate tables, fixed values, quotas, lookup tables, pipeline runs, models, orders, transactions, credits, measurements, incentives, commissions, deposits, payments, earning codes, earning groups, event types, reason codes, users, roles, logs, unit types, calendars, business units, and processing units.

9. The method of claim 1 wherein the automatically generating further includes:
saving the at least one object type, the contents, the validation information, and the plurality of prompts.

10. The method of claim 9 wherein the saving further includes saving the at least one object type, the contents, the validation information, and the plurality of prompts in a flat file.

11. The method of claim 1 wherein the automatically generating further includes:
automatically generating the guide using an XML descriptor.

12. A method for providing a guide for a manager application comprising:
receiving at least one selection of at least one object type by an end-user, each of the at least one object including a plurality of attributes;
allowing addition by the end-user of contents relating to each of the at least one object type, the contents including at least one field;
allowing entry by the end-user of validation information for each of the at least one object type;
allowing selection by the end-user of a plurality prompts relating to the at least one object type, the contents, and/or the validation information; and
automatically generating the guide based on the at least one object type, the contents, the validation information, and the plurality of prompts provided by the end-user;
thereby providing the guide that is field customizable.

13. A computer-readable medium having a program for providing a guide, the program including instructions for:
receiving at least one selection of at least one object type by an end-user, each of the at least one object including a plurality of attributes;
allowing addition by the end-user of contents relating to each of the at least one object type; and
automatically generating the guide based on the at least one object type and the contents;
thereby providing the guide that is field customizable.

14. The computer-readable medium of claim 13 wherein the program further includes instructions for:
allowing entry by the end-user of validation information for each of the at least one object type; and
wherein the automatically generating further includes automatically generating the guide based on the at least one object type, the contents, and the validation information.

15. The computer-readable medium of claim 13 wherein the program further includes instructions for:
allowing selection by the end-user of a plurality prompts relating to the at least one object type, the contents, and the validation information; and
wherein the automatically generating further includes automatically generating the guide based on the at least one object type, the contents, and/or the plurality of prompts provided by the end-user.

16. The computer-readable medium of claim 13 wherein the addition of contents allowing further includes:
allowing the end-user to define a name for at least one page corresponding to a portion of the plurality of objects for each of the at least one object;
allowing a user to specify at least one field for data entry.

17. The computer-readable medium of claim 13 wherein the guide includes a plurality of pages and where the addition of contents allowing further includes grouping a plurality of pages.

18. The computer-readable medium of claim 13 wherein the validation information entering instructions further include:
selecting at least one method for validating the data provided by the user.

19. The computer-readable medium of claim 18 wherein the validation information entering instructions further include:
selecting a plurality of values for the validation information.

20. The computer-readable medium of claim 13 wherein the object type includes at least one of participants, positions, titles, relationships, position groups, categories, products, customers, postal codes, custom classifiers, plans, rules, formulas, variables, territories, rate tables, fixed values, quotas, lookup tables, pipeline runs, models, orders, transactions, credits, measurements, incentives, commissions, deposits, payments, earning codes, earning groups, event types, reason codes, users, roles, logs, unit types, calendars, business units, and processing units.

21. The computer-readable medium of claim 13 wherein the automatically generating further includes:
saving the at least one object type, the contents, the validation information, and the plurality of prompts.

22. The computer-readable medium of claim 21 wherein saving further includes:
saving the at least one object type, the contents, the validation information, and the plurality of prompts in a flat file.

23. The computer-readable medium of claim 13 wherein the automatically generating further includes:
automatically generating an XML guide.

24. A system for providing a guide for a manager application comprising:
a user interface for receiving at least one selection of at least one object type by an end-user and addition by the end-user of contents relating to each of the at least one object type, each of the at least one object including a plurality of attributes;
a guide builder tool coupled with the user interface, the guide builder tool for automatically generating the guide based on the at least one object type and the contents;
a guide engine, coupled with the user interface and the guide builder tool, for displaying the guide to the end-user;
thereby providing the guide that is field customizable.

25. The system of claim 24 wherein the user interface allows entry by the end-user of validation information for each of the at least one object type; and
wherein the guide builder tool automatically generates the guide based on the at least one object type, the contents, and the validation information.

26. The system of claim 24 wherein the user interface further allows selection by the end-user of a plurality prompts relating to the at least one object type, the contents, and/or the validation information; and
wherein the guide builder tool automatically generates the guide based on the at least one object type, the contents, and the plurality of prompts provided by the end-user.

27. The system of claim 24 wherein the guide builder tool generates the guide in XML.

28. The system of claim 27 further comprising:
a configuration data, coupled with the guide builder tool and the guide engine, for managing XML files.

29. The system of claim 24 further comprising:
a repository for storing a plurality of object types from which the at least one object type is selected.

30. The system of claim 24 wherein the addition of contents further includes the contents providing at least one field for data entry.

31. The system of claim 24 wherein the guide includes a plurality of pages and where the addition of contents allowing further includes grouping a plurality of pages.

32. The system of claim 24 wherein the validation information includes at least one method for validating data provided by the user.

33. The system of claim 32 wherein the validation information further includes a plurality of values for the validation information.

34. The system of claim 24 wherein the object type includes at least one of participants, positions, titles, relationships, position groups, categories, products, customers, postal codes, custom classifiers, plans, rules, formulas, variables, territories, rate tables, fixed values, quotas, lookup tables, pipeline runs, models, orders, transactions, credits, measurements, incentives, commissions, deposits, payments, earning codes, earning groups, event types, reason codes, users, roles, logs, unit types, calendars, business units, and processing units.

35. The system of claim 24 wherein the guide builder saves the at least one object type, the contents, the validation information, and the plurality of prompts.

36. The system of claim 35 wherein the guide builder engine saves the at least one object type, the contents, the validation information, and the plurality of prompts in a flat file.

37. The system of claim 36 wherein the guide builder automatically generates an XML guide.
